(19) United States
(12) Patent Application Publication
(10) Pub. No.: US 2016/0070063 A1
(43) Pub. Date: Mar. 10, 2016

(54) OPTICAL COUPLING DEVICE, PHOTOELECTRIC CONVERSION DEVICE AND OPTICAL COMMUNICATION DEVICE

(71) Applicant: HON HAI PRECISION INDUSTRY CO., LTD., New Taipei (TW)

(72) Inventor: HSIN-SHUN HUANG, Tu-Cheng (TW)

(21) Appl. No.: 14/735,544

(22) Filed: Jun. 10, 2015

(30) Foreign Application Priority Data
Sep. 9, 2014 (TW) 103131056

(51) Int. Cl. G02B 6/124; G02B 6/122; G02B 6/30; G02B 6/28; G02B 6/10; G02B 27/42; G02B 6/27; G02B 6/125; G02B 6/42

(52) U.S. Cl. CPC G02B 6/124; G02B 6/125; G02B 6/1228; G02B 6/305; G02B 6/428; G02B 6/105; G02B 27/4261; G02B 6/2773; G02B 6/2817; G02B 2006/1204

(57) ABSTRACT

An optical communication device includes two photoelectric conversion devices, and an optical fiber connection between the photoelectric conversion devices. The photoelectric conversion devices include an optical coupling device, a light emitting device, and an optical receiver. The optical coupling device includes a substrate, a top surface, a bottom surface opposite to the top surface, a first waveguide a second waveguide and a grating, the first connecting portion and the second connecting portion are connected with each other at an overlap area and form a Y-shape, the grating is used to reflect transverse electric waves and passes transverse magnetic waves.

### FIELD

The subject matter herein generally relates to an optical coupling device, a photoelectric conversion device and an optical communication device.

### BACKGROUND

In the field of fiber optical communication technologies, the photoelectric conversion device is used to emit and receive the optical signal. The photoelectric conversion device uses two optical fibers to transmit and receive the optical signal via one optical coupling device.

### BRIEF DESCRIPTION OF THE DRAWINGS

Many aspects of the disclosure can be better understood with reference to the following drawings. The components in the drawings are not necessarily drawn to scale, the emphasis instead being placed upon clearly illustrating the principles of the disclosure. Implementations of the present technology will now be described, by way of example only, with reference to the attached figure.

FIG. 1 is an isometric view of a first embodiment of an optical coupling device.

FIG. 2 is a diagrammatic, cross sectional view along II-II of the first embodiment of the optical coupling device of FIG. 1.

FIG. 3 is an isometric view of the first embodiment of a photoelectric conversion device.

FIG. 4 is a diagrammatic, cross sectional view along IV-IV of the first embodiment of the photoelectric conversion device of FIG. 3.

FIG. 5 is an isometric view of the first embodiment of an optical communication device.

FIG. 6 is a diagrammatic, cross sectional view along VI-VI of the first embodiment of the optical communication device of FIG. 5.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

A definition that applies throughout this disclosure will now be presented.

The term “coupled” is defined as connected, whether directly or indirectly through intervening components, and is not necessarily limited to physical connections. The connection can be such that the objects are permanently connected or releasably connected. The term “comprising,” when utilized, means “including, but not necessarily limited to”; it specifically indicates open-ended inclusion or membership in the so-described combination, group, series and the like.

The present disclosure relates to an optical coupling device, a photoelectric conversion device and an optical communication device.

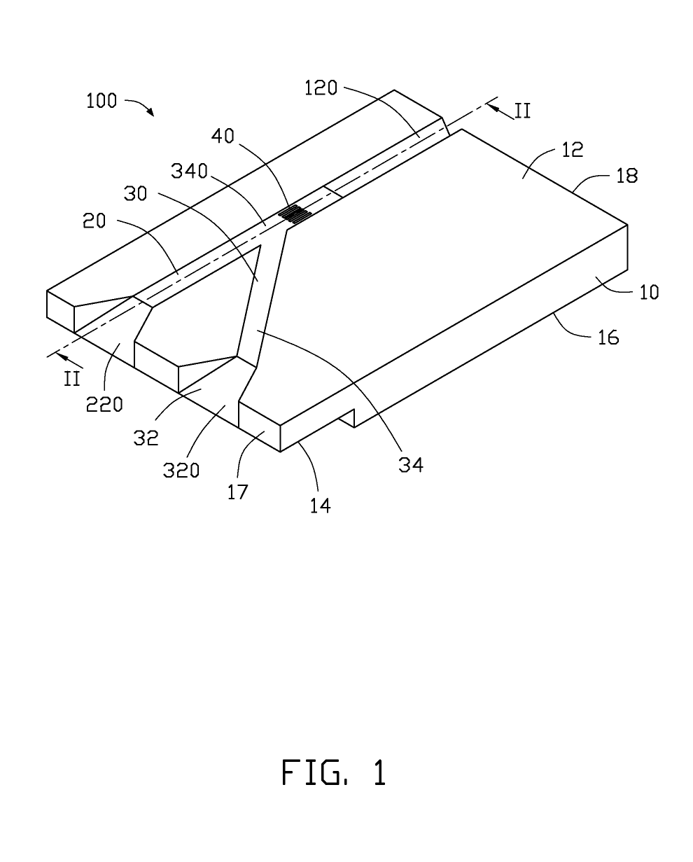

FIG. 1 illustrates an optical coupling device 100, which includes a substrate 10, a first waveguide 20, a second waveguide 30, and a grating 40. The first waveguide 20, the second waveguide 30, and the grating 40 are coupled with the substrate 10.

The substrate 10 includes a top surface 12, a bottom surface 14, a lower surface 16, a first side surface 17, and a second surface 18. The bottom surface 14 and the lower surface 16 are positioned on the same side of the substrate 10 and are opposite to the top surface 12. The bottom surface 14 and the lower surface 16 are parallel to the top surface 12. A gap between the bottom surface 14 and the top surface 12 is shorter than the gap between the lower surface 16 and the top surface 12, at least an edge of the bottom surface 14 is not aligned with an edge of the lower surface 16. The first side surface 17 interconnects between the top surface 12 and the bottom surface 14, and the second side surface 18 opposing to the first side surface 17 interconnects between the top surface 12 and the lower surface 16. In at least one embodiment, the substrate is composed of lithium niobate (LiNbO₃).

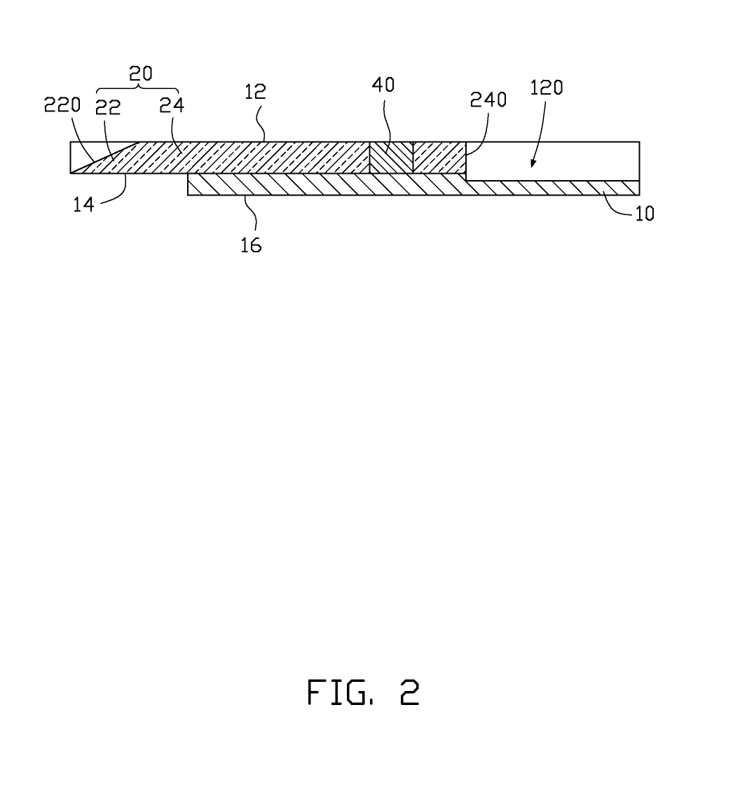

FIG. 2 illustrates the the first waveguide 20. The first waveguide 20 includes a first portion 22 and a first connecting portion 24. The first portion includes a first tilted surface 220. In the illustrated embodiment, the first portion 22 is close to the first side surface 17; the first tilted surface 220 interconnects between the top surface 12 and the bottom surface 14. The width of the first tilted surface 220 is increased from the top surface 12 to the bottom surface 14. The first connecting portion 24 is coupled to the first portion 22 and extends in a first direction away from the first side surface 17. The first connecting portion 24 includes a first surface 240 which is perpendicular to the top surface 12 and is positioned away from the first portion 22. In the embodiment, the first waveguide 20 is a titanium-diffused (“Ti-diffused”) waveguide. The first waveguide 20 is exposed from the top surface 12 and the bottom surface 14.

The second waveguide 30 includes a second portion 32 and a second connecting portion 34. An index of refraction of the second waveguide 30 is different from the index of refraction of the first waveguide 20. The second portion 32 includes a second tilted surface 320. In the illustrated embodiment, the second portion 32 is substantially close to the first side surface 17. The second tilted surface 320 interconnects between the top surface 12 and the bottom surface 14. Additionally, the width of the second tilted surface 320 increases from the top surface 12 to the bottom surface 14. The second connecting portion 34 is coupled to the second portion 32 and extends from the second portion 32 to connect with the first connecting portion 24 at an overlap area 340. The shape of the first connecting portion 24 and the second connecting portion 34 is Y-shaped. In the illustrated embodiment, the second waveguide is a gallium-diffused (“Ga-diffused”) waveguide. The overlap area 340 includes the Ga-diffused waveguide and the Ti-diffused waveguide. The second waveguide 30 is exposed from the top surface 12 and the bottom surface 14. For a specific wavelength range, the index of refraction of the second waveguide 30 is larger than the index of refraction of the first waveguide 20.

The grating 40 is coupled to the first waveguide 20, the grating 40 includes a plurality of metal components, a length direction of the grating 40 is parallel to a length direction of the first waveguide 20. In the illustrated embodiment, the grating 40 is positioned on a side area of the overlap area 340 away from the first portion 22. The side area of the overlap area 340 is positioned between the overlap area 340 and the first surface 240.

In the illustrated embodiment, the substrate includes a groove defined in the top surface. In at least one embodiment, the groove can be a V-groove, wherein the groove has a shape that substantially resembles, in a cross-sectional view, the letter “V.” The V-groove passes through the second side surface 18 and connects to the first surface 240. The V-groove is used to hold an optical fiber.

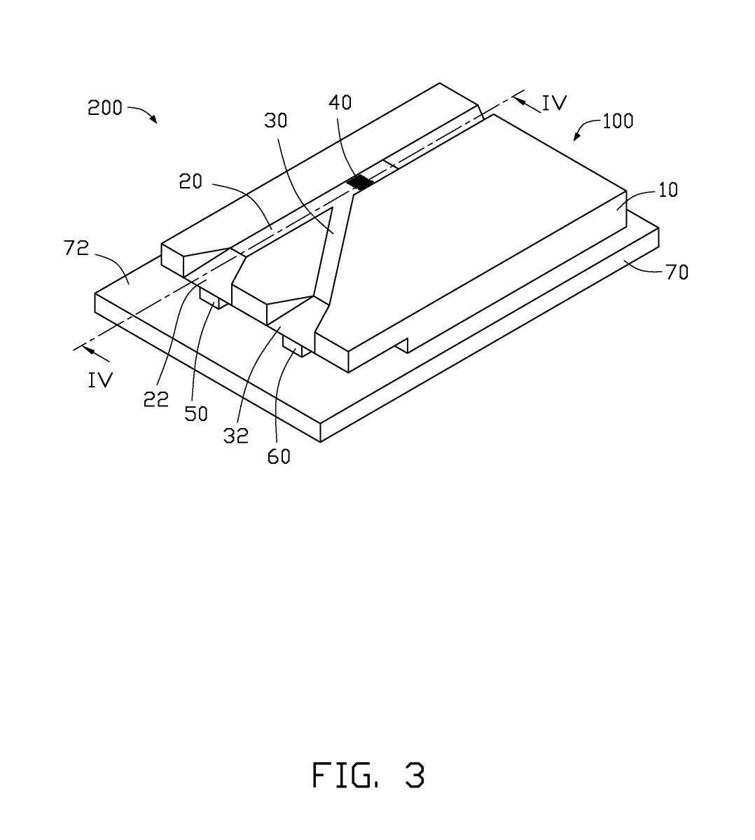

FIG. 3 illustrate a photoelectric conversion device 200, which includes the optical coupling device 100 showed in the first embodiment, a light emitting device 50, an optical receiver 60, and a circuit board 70.

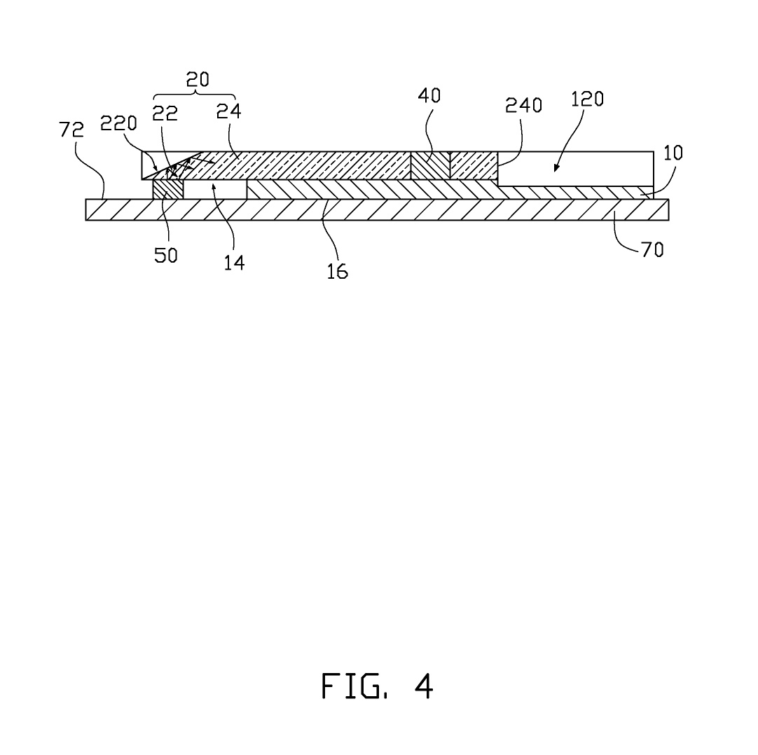

The circuit board 70 includes an upper surface 72, the light emitting device 50 and the optical receiver 60 are positioned on the upper surface 72 and connected electrically with the upper surface 72. The light emitting device 50 corresponds to the first portion 22, and the optical receiver 60 corresponds to the second portion 32. The light emitting device 50 is positioned under the first tilted surface 220, showing in FIG. 4.

When the light emitting device 50 is bias to emit the light, the light passes through the bottom surface 14 to enter the first waveguide 20. The optical receiver 60 is positioned under the second tilted surface 320, and the light is transmitted via the second waveguide 30 and the second portion 32. Additionally, the light passes through the bottom surface 14 to be received by the optical receiver 60. In the illustrated embodiment, the light emitting device 50 is a semiconductor laser; the optical receiver 60 is a photodiode. The lower surface 16 is coupled with the upper surface 72.

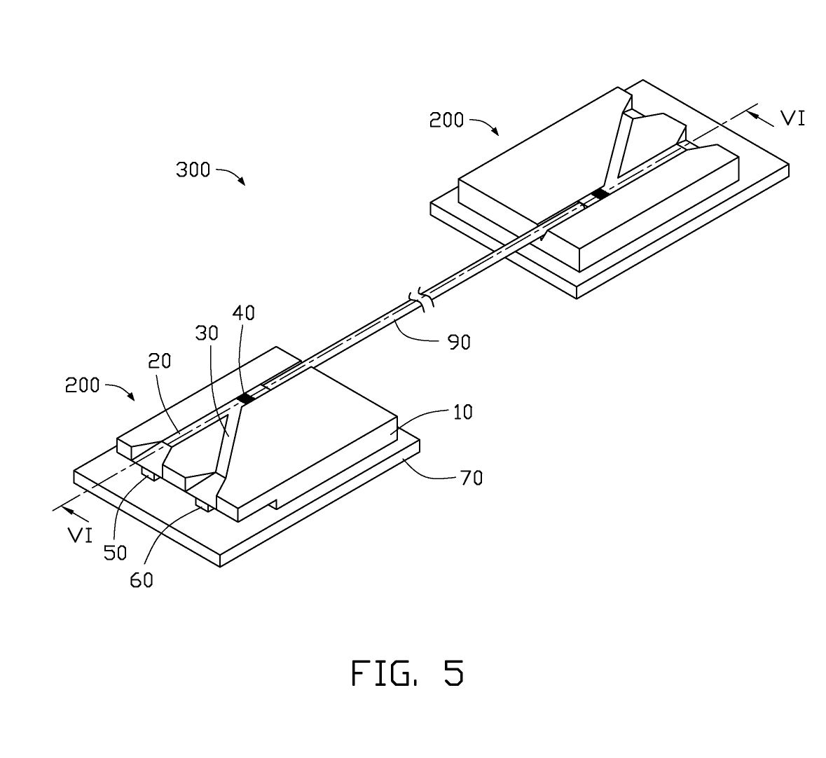

FIG. 5 illustrate an optical communication device 300, which includes two photoelectric conversion devices 200 and an optical fiber 90 connected between the two photoelectric conversion devices 200.

The optical fiber 90 includes two interfaces and is positioned on the V-grooves 120 of the optical coupling devices 100. Each one of the interfaces is corresponding to the first surface 240, and the optical fiber 90 is coupled to the first waveguides 20.

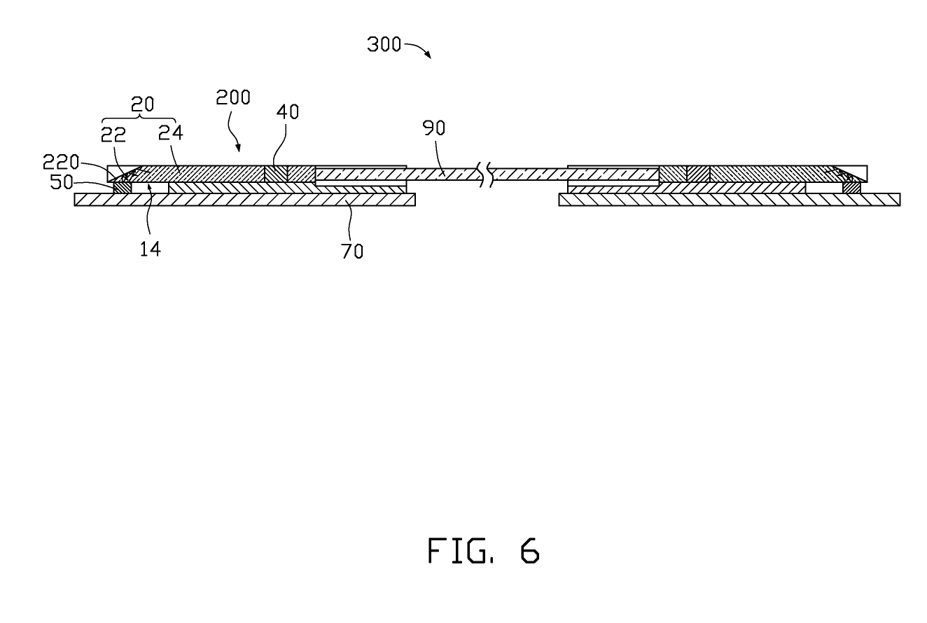

Each one of the light emitting devices 50 of the photoelectric conversion devices 200 emits light rays toward the bottom surface 14, showing in FIG. 6, the light rays pass through the bottom surface 14 to input the first portion 22 of the first waveguide 20 and are reflected to the first connecting portion 24 by the first tilted surface 220, the light rays includes transverse electric waves and transverse magnetic waves. When the light rays reach the grating 40, the transverse electric waves are reflected by the grating 40. Additionally, the transverse magnetic waves pass through the grating 40 to emit out of the first surface 240 of the first connecting surface 24. Furthermore, the transverse magnetic waves are input to the optical fiber 90. The transverse magnetic waves are transmitted by the optical fiber 90 to the other photoelectric conversion devices 200. The transverse magnetic waves are further input into the photoelectric conversion devices 200 and pass through the grating 40 in each of the plurality of metal components to reach the overlap area 340. The index of refraction of the second waveguide 30 is larger than the index of refraction of the first waveguide 20. Therefore, the transverse magnetic waves are transmitted to the second portion 32 by the second connecting portion 34, and pass through the bottom surface 14 to the optical receiver 60.

The embodiments shown and described above are only examples. Many details are often found in the art such as the other features of an optical coupling device, a photoelectric conversion device and an optical communication device. Therefore, many such details are neither shown nor described. Even though numerous characteristics and advantages of the present technology have been set forth in the foregoing description, together with details of the structure and function of the present disclosure, the disclosure is illustrative only, and changes may be made in the details, including in matters of shape, size, and arrangement of the parts within the principles of the present disclosure, up to and including the full extent established by the board general meaning of the terms used in the claims. It will therefore be appreciated that the embodiments described above may be modified within the scope of the claims.

What is claimed is:

1. An optical coupling device, comprising:
a substrate including a top surface, and a bottom surface opposite to the top surface;
a first waveguide including a first portion and a first connecting portion, the first portion including a first tilted surface interconnecting between the top surface and the bottom surface and increasing in width from the top surface to the bottom surface;
a second waveguide having an index of refraction that is different from an index of refraction of the first waveguide, the second waveguide including a second portion and a second connecting portion, the second portion including a second tilted surface interconnecting between the top surface and the bottom surface and increasing in width from the top surface to the bottom surface;
a grating coupled to the first waveguide, the grating is configured to reflect transverse electric waves of light rays and allow transverse magnetic waves of the light rays to pass through;
wherein the first waveguide, the second waveguide, and the grating are coupled to the substrate;
wherein the first connecting portion and the second connecting portion are connected with each other at an overlap area and form a Y-shape.

2. The optical coupling device in accordance with claim 1, wherein the substrate is formed from lithium niobate, the first waveguide is a Ti-diffused waveguide, the second waveguide is a Ga-diffused waveguide.

3. The optical coupling device in accordance with claim 1, wherein the grating includes a plurality of metal components, a length direction of grating is parallel to a length direction of the first waveguide, the grating is positioned to a side area of the overlap area away from the first portion.

4. The optical coupling device in accordance with claim 1, wherein the first connecting portion includes a first surface that is perpendicular to the top surface and is positioned away from the first portion, the substrate includes a V-groove defined in the top surface, the V-groove is configured to hold a optical fiber and connects to the first surface.

5. A photoelectric conversion device, comprising:
an optical coupling device, comprising:
a substrate including a top surface, and a bottom surface opposite to the top surface;
a first waveguide including a first portion and a first connecting portion, the first portion including a first tilted surface interconnecting between the top surface and the bottom surface;
a second waveguide having an index of refraction that is different from an index of refraction of the first waveguide, the second waveguide including a second portion and a second connecting portion, the second portion including a second tilted surface interconnecting between the top surface;
a grating coupled to the first waveguide;
wherein the first waveguide, the second waveguide, and the grating is coupled with the substrate;
a light emitting device corresponding to the first portion;
an optical receiver corresponding to the second portion;
wherein the first connecting portion and the second connecting portion are connected with each other at an overlap area and formed a Y-shape, widths of the first tilted surface and the second tilted surface increase from the top surface to the bottom surface, the grating is configured to reflecting transverse electric waves of light rays and is passed through by transverse magnetic waves of the light rays.

6. The photoelectric conversion device in accordance with claim 5, wherein the photoelectric conversion device includes a circuit board, the light emitting device and the optical receiver connect with the circuit board.

7. The photoelectric conversion device in accordance with claim 6, wherein the light emitting device is positioned under the first tilted surface, the optical receiver is positioned under the second tilted surface.

8. The photoelectric conversion device in accordance with claim 6, wherein the light emitting device is a semiconductor laser, the optical receiver is a photodiode.

9. An optical communication device, comprising:
two photoelectric conversion devices, the photoelectric conversion devices comprising:
an optical coupling device, comprising:
a substrate including a top surface, and a bottom surface opposite to the top surface;
a first waveguide including a first portion and a first connecting portion, the first portion including a first tilted surface interconnecting between the top surface and the bottom surface;
a second waveguide having an index of refraction that is different from an index of refraction of the first waveguide, the second waveguide including a second portion and a second connecting portion, the second portion including a second tilted surface interconnecting between the top surface;
a grating coupled to the first waveguide;
wherein the first waveguide, the second waveguide, and the grating is coupled with the substrate;
a light emitting device corresponding to the first portion;
an optical receiver corresponding to the second portion;
an optical fiber connected between the photoelectric conversion devices;
wherein the first connecting portion and the second connecting portion are connected with each other at an overlap area and formed a Y-shape, widths of the first tilted surface and the second tilted surface increase from the top surface to the bottom surface, the grating is configured to reflecting transverse electric waves of light rays and is passed through by transverse magnetic waves of the light rays.

10. The optical communication device in accordance with claim 9, wherein the first connecting portion includes a first surface that is perpendicular to the top surface and is positioned away from the first portion, the substrate includes a V-groove defined in the top surface, the V-groove is configured to hold the optical fiber and connects to the first surface.

11. The optical communication device in accordance with claim 9, wherein the photoelectric conversion device includes a circuit board, the light emitting device and the optical receiver connect with the circuit board, the light emitting device is a semiconductor laser, the optical receiver is a photodiode.
